(19) United States
(12) Patent Application Publication
(10) Pub. No.: US 2025/0383648 A1
(43) Pub. Date: Dec. 18, 2025

(54) METHODS AND DEVICES FOR MANAGING A CUSTOMER INSTALLATION IN A RESOURCE DISTRIBUTION NETWORK

(71) Applicant: SAGEMCOM ENERGY & TELECOM SAS, BOIS-COLOMBES (FR)

(72) Inventors: Henri TEBOULLE, Bois-Colombes (FR); Mohand MOULAI, Bois-Colombes (FR); Nuno TEIXEIRA MARTINS, Bois-Colombes (FR)

(21) Appl. No.: 19/237,768

(22) Filed: Jun. 13, 2025

(30) Foreign Application Priority Data
Jun. 14, 2024 (FR) 2406355
Feb. 2, 2025 (EP) 25158965.1

(51) Int. Cl. G05B 19/418

(52) U.S. Cl. CPC G05B 19/418; G05B 2219/2642

(57) ABSTRACT

The method described relates to a resource distribution network comprising an information server and customer installations. It applies, for example, to an electricity distribution network. The method enables customer installations on the distribution network to be controlled according to a resource production carbon intensity forecast. For example, it may comprise sending a load-shedding command to a home automation device configured to manage the customer installation.

### CROSS-REFERENCE TO RELATED APPLICATIONS

The present application claims priority to French Application No. 2406355 filed with the Intellectual Property Office of France on Jun. 14, 2024, and also claims priority to European Application No. 25158965.1 filed with the European Patent Office on Feb. 2, 2025, both of which are incorporated herein by reference in their entirety for all purposes.

### TECHNICAL FIELD

The various embodiments described in the present disclosure relate to a distribution network for a resource, for example a distribution network for electricity, gas, heat, etc., as well as the customer installations of such a network, in particular the meters.

### BACKGROUND

The carbon intensity of electricity generation is a measure that indicates the amount of carbon dioxide (CO2) emitted per unit produced. It is generally expressed in grams of CO2 per kilowatt-hour (g CO2/kWh). This measure enables the environmental impact of the different energy sources used for production to be assessed.

Carbon intensity varies considerably according to the type of technology and fuel used. For example, in electricity generation, renewable energies such as wind, solar and hydroelectric power have a very low carbon intensity, often close to zero. Nuclear power sources are also low-carbon, although there are emissions associated with the life cycle of nuclear fuel and plant construction. Conversely, fossil fuel power plants, such as those burning coal, oil or natural gas, have a high carbon intensity due to the large quantities of CO2 emitted when these fuels are burned.

Reducing carbon intensity is a key objective for energy policies aimed at combating climate change, by encouraging the deployment of cleaner, more efficient technologies.

### SUMMARY

A first aspect relates to a method for managing a distribution network for a resource supplied by one or more energy sources with a capacity known in advance, in a distribution network comprising customer installations each comprising a meter, and an information server which comprises a metering data manager module and a head-end for communicating with the customer installations. The meter is configured to measure consumption of the resource by the customer and transmit customer information representative of the customer's consumption to the information server. The metering data manager module is configured to determine a global forecast load curve for all customers based on said customer information. The method comprises steps, executed by the information server, for:
determining a resource production carbon intensity forecast for at least one period of time, based on the forecast load curve and the capacity supplied by the one or more energy sources used,
transmitting information to one or more customer installations enabling control of said customer installations over said at least one time period based on the carbon intensity forecast,
the transmitted information comprising, or being intended to be used to determine, a load-shedding command intended for a home automation device, configured to manage the customer installation, to reduce or stop the operation of one or more pieces of equipment in the customer installation which, when operating, consume said resource.

In a first embodiment of the method for managing a distribution network, the information transmitted includes the load-shedding command, and the load-shedding command is transmitted via an application programming interface of the information server to an Internet access point of the customer installation.

In a second embodiment of the method for managing a distribution network, the information transmitted includes the carbon intensity forecast. It is transmitted to the meter of the customer installation via a telecommunications network so that the meter can determine the load-shedding command and transmit it to the home automation device.

A second aspect relates to a method for managing a customer installation in a network for distributing a resource supplied by one or more energy sources with a capacity known in advance, in a network including customer installations each including a meter, and an information server which includes a metering data manager module and a head-end for communicating with the customer installations. The meter is configured to measure consumption of the resource by the customer and transmit customer information representative of the customer's consumption to the information server. The metering data manager module is configured to determine a global forecast load curve for all customers based on said customer information. The method includes steps for:
receiving from the information server information comprising a resource production carbon intensity forecast for at least one period of time, the carbon intensity forecast being determined based on the forecast load curve and the capacity supplied by the one or more energy sources used,
processing the information received to enable control of the customer installation over said at least one period of time based on the carbon intensity forecast,
the step for processing the information received comprises a determination, or a transmission of the information received with a view to determining, a load-shedding command intended for a home automation device configured to manage the customer installation, for said at least one period of time, to reduce or stop the operation of one or more pieces of equipment of the customer installation which in operation consume said resource.

In a first embodiment of the method for managing a customer installation, the step for processing the received information comprises determining the load-shedding command and transmitting the load-shedding command to a home automation device of the customer installation configured to manage the customer installation.

In a second embodiment of the method for managing a customer installation, the step for processing the information received comprises transmission of the carbon intensity forecast to a remote information device connected to the meter and configured to determine the load-shedding command and to transmit it to the home automation device.

Advantageously, the method for managing the customer installation comprises a step of displaying one or more data representative of the carbon intensity forecast on a meter display module or on a remote display module.

A third aspect relates to a method for managing a customer installation in a network for distributing a resource supplied by one or more energy sources with a capacity known in advance, in a network including customer installations each including a meter, and an information server which includes a metering data manager module and a head-end for communicating with the customer installations. And wherein the meter is configured to measure consumption of the resource by the customer and transmit customer information representative of the customer's consumption to the information server. And the metering data manager module is configured to determine a global forecast load curve for all customers based on said customer information. The method includes steps for:
receiving from a meter of the customer installation a carbon intensity forecast of resource production for at least one period of time, the carbon intensity forecast being determined based on the forecast load curve and the capacity supplied by the one or more energy sources used,
determining, on the basis of the carbon intensity forecast received, a load-shedding command for said at least one period of time, to reduce or stop the operation of one or more pieces of equipment in the customer installation which in operation consume said resource,
transmitting the load-shedding command to a home automation device configured to manage the customer installation.

A fourth aspect relates to an information server device comprising means for implementing a method for managing a resource distribution network as described above.

A fifth aspect relates to a meter comprising means for implementing a method for managing a customer installation as described above.

A sixth aspect relates to a remote information device comprising means for implementing a method for managing a resource distribution network as described above.

The information server, meter and remote information devices can be constituted by software means, that is, instructions intended to be executed by a set of circuits to perform one or more or all of the operations or steps to be carried out, in application of the methods described herein. The circuit assembly may consist of dedicated circuitry. Alternatively, it may be made up of one or more processors and one or more memories comprising one or more computer program codes, said processors, memories and computer codes being configured to cause the information server, the meter and/or remote information device to execute one or more or all of the steps of the methods described herein.

A seventh aspect relates to a computer program product comprising instructions which when executed by at least one processor cause the implementation of a method for managing a distribution network or a method for managing a customer installation as described above.

An eighth aspect relates to a non-transitory computer-readable storage medium comprising instructions which when executed by a processor cause the implementation of a method for managing a distribution network or a method for managing a customer installation as described above.

### BRIEF DESCRIPTION OF THE FIGURES

The embodiments will be better understood in light of the following detailed description and the accompanying drawings, which are given by way of illustration only and therefore do not limit the present disclosure.

FIG. 1 is a block diagram of an example of a system for a resource distribution network.

FIG. 2 is a diagram describing the steps of a method for managing a resource distribution network.

FIG. 3 is a diagram describing the steps of a method for managing a customer installation in a resource distribution network, to be carried out by a meter of a customer installation in the distribution network.

FIG. 4 is a diagram describing the steps of a method for managing a customer installation in a resource distribution network, to be carried out by a remote information device connected to a meter of a customer installation in the distribution network

FIG. 5 shows an example of a production carbon intensity forecast curve as a function of time of day.

FIG. 6 shows an example of a load curve for a given customer when the carbon intensity for production is not taken into account.

FIG. 7 shows an example of a load curve for the same customer as shown in FIG. 6, when the customer installation is controlled based on the carbon intensity forecast shown in FIG. 5.

FIG. 8 is a block diagram of a device for implementing an information server, meter and/or remote information device as described herein.

### DETAILED DESCRIPTION

Various embodiments will now be described in more detail, by way of non-limiting examples, with reference to the drawings accompanying the present disclosure and illustrating certain exemplary embodiments.

The specific structural and functional details disclosed herein are non-limiting examples. The embodiments disclosed here may undergo various modifications and alternative forms. The subject matter of the disclosure may be embodied in many different forms and should not be construed as being limited solely to the embodiments presented herein as illustrative examples. It should be understood that there is no intention to limit the embodiments to the particular forms described in the remainder of this document.

In the following description, identical, similar or analogous elements will be referred to by the same reference numbers. The block diagrams, flowcharts and message sequence diagrams in the figures shows the architecture, functionalities and operation of systems, apparatuses, methods and computer program products according to one or more exemplary embodiments. Each block of a block diagram or each step of a flowchart may represent a module or a portion of software code comprising instructions for implementing one or more functions. According to certain implementations, the order of the blocks or the steps may be changed, or else the corresponding functions may be implemented in parallel. The method blocks or steps may be implemented using circuits, software or a combination of circuits and software, in a centralized or distributed manner, for all or part of the blocks or steps. The described systems, devices, processes and methods may be modified or subjected to additions and/or deletions while remaining within the scope of the present disclosure. For example, the components of a device or system may be integrated or separated. Likewise, the features disclosed may be implemented using more or fewer components or steps, or even with other components or by means of other steps. Any suitable data-processing system can be used for the implementation. An appropriate data-processing system or device comprises for example a combination of software code and circuits, such as a processor, controller or other circuit suitable for executing the software code. When the software code is executed, the processor or controller prompts the system or apparatus to implement all or part of the functionalities of the blocks and/or steps of the processes or methods according to the exemplary embodiments. The software code can be stored in non-volatile memory or on a non-volatile storage medium (USB key, memory card or other medium) that can be read directly or via a suitable interface by the processor or controller.

The present disclosure applies to any resource distribution network comprising at least one information server and a plurality of meters measuring the consumption of said resource. For example, this could be a distribution network for electricity, gas, heat, etc.

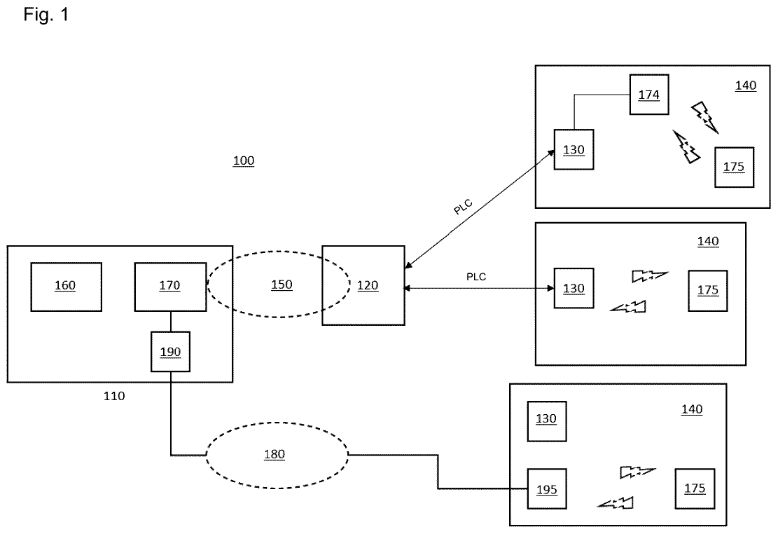

In the non-limiting example shown in FIG. 1, a resource distribution network 100 comprises at least one information server 110 which is intended to communicate via a sub-distributor 120 with a plurality of meters 130 which are installed on customer premises 140. For example, the information server 110 communicates with the sub-distributor 120 via a wireless telecommunications network 150. The wireless telecommunications network 150 can be a GPRS, UMTS, LTE, 5G or narrowband IoT (Internet-of-Things) network. For example, the sub-distributor 120 communicates with the meters 130 via the electrical network using power line communication (PLC). For example, data is exchanged between the meters 130 and the head-end 170 using DLMS/COSEM-compliant data frames.

Customer installations 140 include pieces of equipment which, when in operation, consume the resource distributed by the distribution network.

The information server 110 includes, for example, a metering data management module 160 (known by the acronym MDM) and a head-end 170 that manages communications protocols for communicating with customer installations 140.

In some embodiments, the customer installation 140 comprises, in addition to the meter 130, a remote information device 174 which is connected to the meter 130 and is configured to communicate with a home automation device 175. The home automation device 175 is a customer device configured to manage the customer installation. For example, the communication between the meter 130 and the remote information device is a serial communication in asynchronous mode with ASCII coding at a speed of 1200 or 9600 bit/s.

Alternatively, the meter 130 is configured to communicate directly with the home automation device 175. In this case, communication with the home automation device 175 is via Wi-Fi, for example.

The head-end 170 can also communicate with the meter 130 of the customer installation 140 via the Internet network 180. In this case, the information server includes a dedicated application programming interface (API) 190 that communicates with an Internet access point 195 of the customer installation. The customer installation's Internet access point can then route the information to the home automation device 175, for example via Wi-Fi.

The meters 130 are configured to measure consumption by the customer 140 of the resource distributed via the distribution network. For example, when the network is an electricity distribution network, the meter 130 measures the electricity consumption.

Each of the meters 130 is further configured to transmit customer information to the information server 110, representative of the consumption by the customer 140 over a given period of time.

For example, the meters 130 transmit information representative of their daily consumption. This customer information comprises, for example, a consumption value per time slot of a given duration, for example every 15 minutes. The values transmitted for each 15-minute time slot during the day are used to establish a load curve for the customer for the day. In this way, differences in consumption profiles depending on the day of the week can be taken into account.

The metering data management module 160 can thus determine an overall forecast load curve for all customers, based on consumption data reported by each customer, for example for each day of the week.

Furthermore, the carbon intensity of production depends on the ability to use renewable energies efficiently, and the need to produce or import other energy sources considered non-green to meet demand.

The information server 110 knows in advance (e.g. 6 h in advance in the embodiment described here) the production resources used and the capacity they can provide. It can therefore determine a resource production carbon intensity forecast, based on the forecast load curve, for example for the next 6 hours, in 15-minute increments.

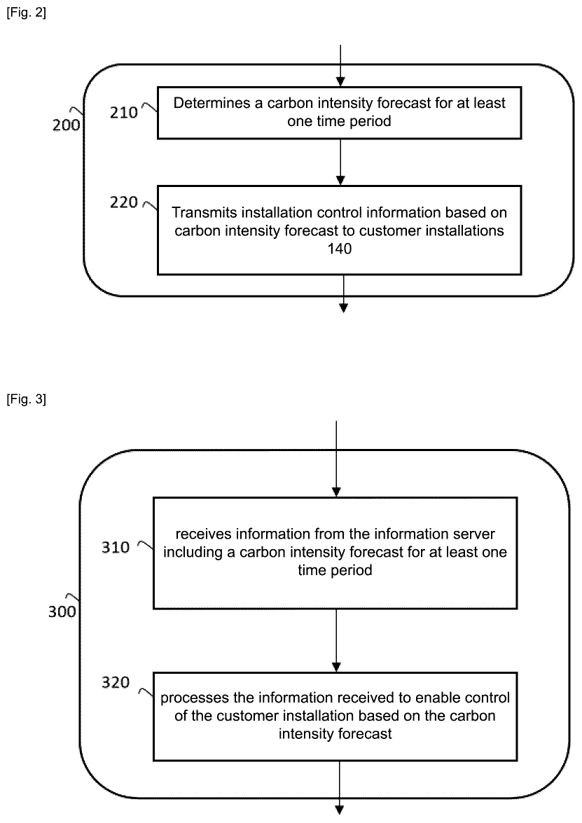

FIG. 2 is a flowchart representing the main steps of a method 200 for managing a resource distribution network as described here. In step 210, the information server 110 (e.g. the metering data manager module 160 of the information server 110) determines a resource production carbon intensity forecast for at least one time period, e.g. for the next 6 hours, broken down into 15-minute segments. Then, in step 220, the information server 110 transmits information to one or more customer installations 140, enabling said customer installations to be controlled based on the carbon intensity forecast.

For example, when the head-end 170 communicates with the meter 130 of the customer installation 140 via the Internet network 180, the information transmitted includes a load-shedding command for the home automation device 175.

In another example, when the head-end 170 communicates with the meter 130 of the customer installation 140 via the telecommunications network 150, the information transmitted includes the carbon intensity forecast, and the meter 130 is configured to process the information received to enable control of the customer installation 140 based on the carbon intensity forecast.

FIG. 3 is a flowchart representing the main steps of a method 300 for managing a customer installation of a resource distribution network, to be carried out by the meter 130. It comprises a step 310 for receiving, from the information server, information including a resource production carbon intensity forecast for at least one time period, and a step 320 for processing the received information to enable control of the customer installation based on the carbon intensity forecast.

In a first embodiment, step 320 comprises determining a load-shedding command for one or more time periods from the carbon intensity forecast, and transmitting the load-shedding command to the home automation device 175 which is configured to manage the customer installation 140.

In a second embodiment, step 320 involves transmitting the carbon intensity forecast to the remote information device 174, which is configured to determine a load-shedding command for one or more time periods on the basis of the carbon intensity forecast, and to transmit it to the home automation device 175.

For example, the home automation device 175 can be configured to pass on or not pass on a received load-shedding command, and/or to apply different load-shedding modalities according to one or more criteria.

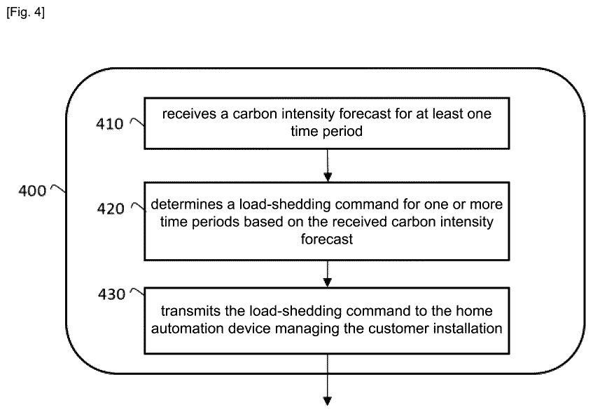

FIG. 4 is a flowchart showing the main steps in another method 400 for managing a customer installation in a resource distribution network. This method is intended to be carried out by the remote information device 174. It comprises a step 410 for receiving, from the meter, 130 a resource production carbon intensity forecast for at least one time period, a step 420 for determining a load-shedding command for one or more time periods from the received carbon intensity forecast, and a step 430 for transmitting the load-shedding command to the home automation device configured to manage the customer installation 140.

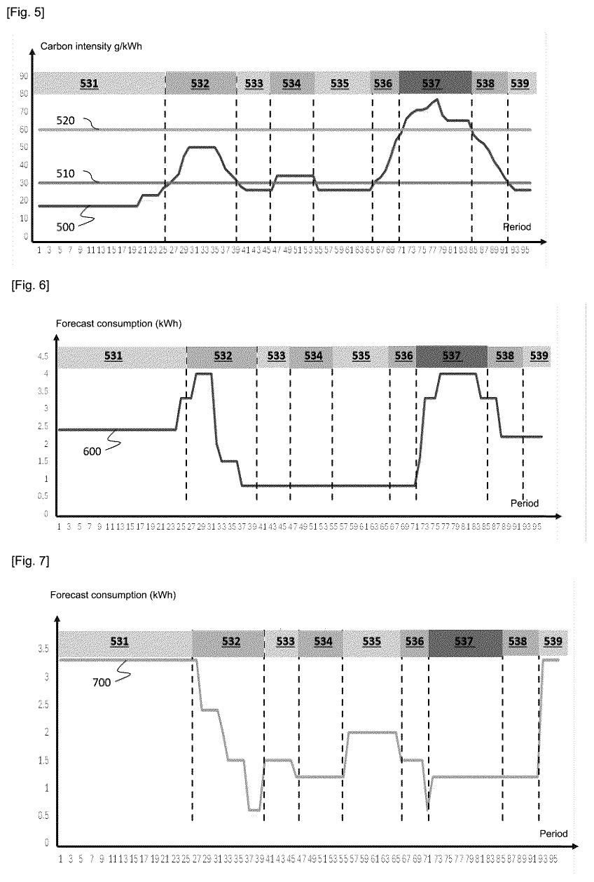

In FIG. 5, curve 500 shows an example carbon intensity forecast as a function of periods of the day (96 periods of 15 minutes in a day). Two thresholds 510 and 520 are shown which, in this example, correspond to a value of 30 gCO2/kWh and 60 gCO2/kWh, respectively. Thus, three types of period can be defined during the day: a first type of period where the forecast carbon intensity is less than or equal to the first threshold 510 (periods 531, 533, 535 and 539 shown in light grey in FIG. 5), a second type of period where the forecast carbon intensity is between the first threshold 510 and the second threshold 520 (periods 532, 534, 536 and 538 shown in medium grey in FIG. 5), and a third type of period where the forecast carbon intensity is greater than or equal to the second threshold 520 (period 537 shown in dark gray in FIG. 5).

In one embodiment, in addition to determining and transmitting a load-shedding command, one or more data representative of the carbon intensity forecast are displayed on a display module of the meter 130 or on a remote display module, for example at the home automation device 175, or a cell phone, tablet etc. In one embodiment, one or more LEDs are illuminated on the meter 130 indicating the type of period in progress, for example a green LED for periods of the first type, an orange LED for periods of the second type, and a red LED for periods of the third type. Alternatively, a multicolor diode can be used, which can take on 3 different colors (green, orange or red), or the backlighting of a display integrated into the meter can be varied (e.g. backlighting off for periods of the first type, slow flashing (e.g. 0.5 Hz) for periods of the second type, fast flashing (e.g. 2 Hz) for periods of the third type). The use of a remote display allows more precise information to be displayed, such as a curve showing the evolution of the production carbon intensity forecast.

The information display, for example, enables customers to take direct action on their installation, such as switching off radiators to reduce consumption.

In FIG. 6, curve 600 shows an example of a load curve for a given customer when the carbon intensity for production is not taken into account. The customer has a high consumption during periods 532 and 537, which is not optimal from the point of view of the carbon intensity produced.

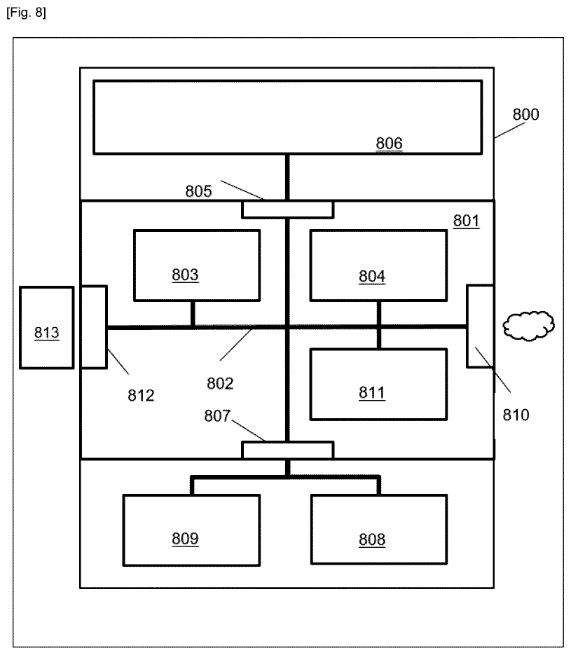

In FIG. 7, curve 700 shows an example of a load curve for the same customer, when the customer installation is controlled based on the carbon intensity forecast.

For example, during period 537 (third type), a load-shedding command is applied to reduce or stop the operation of high-consumption equipment (such as heating or hot water production equipment) and the start-up of additional equipment is postponed (e.g. washing machine, dryer, electric car charging). Whereas during period 532 (second type), the start-up of additional equipment is postponed, but no load shedding takes place. As shown in FIG. 7, consumption falls in the two periods 532 and 537 and rises in the other periods.

The above example describes two thresholds and three types of period. This is a non-exhaustive example. It is of course possible to define just one threshold and two period types, or to define more than two thresholds and more than three period types. It is also possible to add other customer facility management criteria, for example to take into account a customer consumption threshold in addition to the carbon intensity threshold(s). The home automation device 175 can thus be configured to implement one or more load-shedding modes, depending on the management criteria that have been configured.

The information server 110, the meters 130, the remote information devices 174 can, for example, be implemented in the form of a device as shown in FIG. 8. The referenced device 800 comprises a printed circuit board 801 on which a communication bus 802 connects a processor 803, a random access memory 804, a storage medium 811, optionally an interface 805 for connecting a display 806, a series of connectors 807 for connecting user interface devices or modules such as a mouse or trackpad 808 and a keyboard 809, one or more communication interfaces 810 and/or 812; some modules of FIG. 8 may be internal or connected to the outside, in which case they are not necessarily an integral part of the device itself. For example, the display 806 may be a display that is only connected to the device 800 in specific circumstances, or the device 800 may be controlled by another device with a display, in which case the device 800 has no display 806 or interface 805. Depending on the functionality required, especially whether the device 800 is being used in a head-end 170, a meter 130, or a remote information device 174, the device may implement only some of the foregoing. For example, a meter 130 and a remote information device 174 are not usually connected to a mouse, trackpad or keyboard.

The memory 811 contains one or more software codes which, when executed by the processor 803, enable the device 800 to perform the methods disclosed herein. In one exemplary embodiment, a removable storage medium 813, such as a USB key, can also be connected. For example, the detachable storage medium 813 may contain software codes to be downloaded into the memory 811.

The processor 803 can be any type of processor such as a central processing unit (“CPU”) or a dedicated microprocessor such as an integrated microregulating member or digital signal processor (“DSP”).

The device 800 may also comprise other components typically found in computer systems, such as an operating system, queue managers, device drivers, or one or more network protocols that are stored in the memory 811 and executed by the processor 803.

The person skilled in the art will understand that all the block diagrams presented here represent conceptual views, given by way of example, of circuits incorporating the principles of the disclosure.

Each function, block, and step described can be implemented in hardware, software, firmware, middleware, microcode or any suitable combination thereof. If implemented in software, the functions or blocks of the block diagrams and flowcharts can be implemented by computer program instructions/software codes, which can be stored or transmitted on a computer-readable medium, or loaded onto a general-purpose computer, special-purpose computer or other programmable processing device and/or system, so that the computer program instructions or software code running on the computer or other programmable processing device create the means for implementing the functions described in this description.

Although aspects of this disclosure have been described with reference to specific achievements, it should be understood that these achievements merely illustrate the principles and applications of this disclosure. It is therefore understood that numerous modifications can be made to the illustrative embodiments and that other arrangements can be devised without departing from the spirit and scope of the disclosure as determined on the basis of the claims and their equivalents.

Advantages and solutions to problems have been described above with regard to specific embodiments of the invention. However, advantages, benefits, solutions to problems, and any element which may cause or result in such advantages, benefits or solutions, or cause such advantages, benefits or solutions to become more pronounced shall not be construed as a critical, required, or essential feature or element of any or all of the claims.

1. A method of managing a distribution network for a resource supplied by one or more energy sources with a capacity known in advance, the distribution network comprising customer installations each comprising a meter, and an information server comprising a metering data manager module and a head-end for communicating with the customer installations, the meter being configured to measure consumption of the resource by the customer and to transmit, to the information server, customer information representative of the customer's consumption, the metering data manager module being configured to determine an overall forecast load curve for all customers from said customer information, characterized in that it comprises steps, executed by the information server, for:
determining a resource production carbon intensity forecast for at least one period of time, based on the forecast load curve and the capacity supplied by the one or more energy sources used,
transmitting to one or more customer installations information enabling said customer installations to be controlled over said at least one period of time based on the carbon intensity forecast, the information transmitted comprising, or being intended to be used to determine, a load-shedding command intended for a home automation device, configured to manage the customer installation, to reduce or stop an operation of one or more pieces of equipment in the customer installation which in operation consume said resource.

2. The method according to claim 1, wherein the information transmitted comprises the load-shedding command, and in that it is transmitted via an application programming interface from the information server to an Internet access point of the customer installation.

3. The method according to claim 1, wherein the transmitted information comprises the carbon intensity forecast, and in that it is transmitted to the meter of the customer installation via a telecommunications network so that the meter can determine the load-shedding command and transmit it to the home automation device.

4. A method of managing a customer installation in a distribution network for a resource supplied by one or more energy sources with a capacity known in advance, said network comprising customer installations each of which includes a meter, and an information server which includes a metering data manager module and a head-end for communicating with the customer installations, the meter being configured to measure consumption of the resource by the customer and to transmit, to the information server, customer information representative of the customer's consumption, the metering data manager module being configured to determine an overall forecast load curve for all customers from said customer information, characterized in that it comprises steps for:
receiving from the information server information comprising a resource production carbon intensity forecast for at least one period of time, the carbon intensity forecast being determined based on the forecast load curve and the capacity supplied by the one or more energy sources used,
processing the information received to enable control of the customer installation over said at least one period of time as a function of the carbon intensity forecast, said step for processing the information received comprising a determination, or a transmission of the information received with a view to determining, a load-shedding command intended for a home automation device configured to manage the customer installation, for said at least one period of time, to reduce or stop an operation of one or more pieces of equipment of the customer installation which in operation consume said resource.

5. The method according to claim 4, wherein the step for processing the received information comprises a determination of the load-shedding command, and a transmission of the load-shedding command to the home automation device.

6. The method according to claim 4, wherein the step for processing the information received comprises transmission of the carbon intensity forecast to a remote information device connected to the meter and configured to determine the load-shedding command and to transmit it to the home automation device.

7. The method according to claim 4, wherein it comprises a step of displaying one or more data representative of the carbon intensity forecast on a meter display module or on a remote display module.

8. A method of managing a customer installation in a distribution network for a resource supplied by one or more energy sources with a capacity known in advance, said network comprising customer installations each of which includes a meter, and an information server which includes a metering data manager module and a head-end for communicating with the customer installations, the meter being configured to measure consumption of the resource by the customer and to transmit, to the information server, customer information representative of the customer's consumption, the metering data manager module being configured to determine an overall forecast load curve for all customers from said customer information, characterized in that it comprises steps for:
receiving from a meter of the customer installation a resource production carbon intensity forecast for at least one period of time, the carbon intensity forecast being determined based on the forecast load curve and the capacity supplied by the one or more energy sources used,
determining, on the basis of the carbon intensity forecast received, a load-shedding command for said at least one period of time, to reduce or stop an operation of one or more pieces of equipment in the customer installation which in operation consume said resource,
transmitting the load-shedding command to a home automation device configured to manage the customer installation.

9. An information server device comprising means for implementing a method according to claim 1.

10. A meter device comprising means for implementing a method according to claim 4.

11. A remote information device comprising means for implementing a method according to claim 8.

12. A computer program product including instructions which when executed by at least one processor cause the implementation of a method according to claim 1.

13. A non-transitory computer-readable storage medium comprising instructions which when executed by a processor cause the implementation of a method according to claim 1.
